(19) United States
(12) Patent Application Publication
(10) Pub. No.: US 2006/0107281 A1
(43) Pub. Date: May 18, 2006

(54) Remotely controlled electronic device responsive to biometric identification of user

(76) Inventor: Randy R. Dunton, Phoenix, AZ (US)

Correspondence Address: BUCKLEY, MASCHOFF, TALWALKAR LLC, 5 ELM STREET, NEW CANAAN, CT, 06840, US

(21) Appl. No.: 10/987,796

(22) Filed: Nov. 12, 2004

(51) Int. Cl. G06K 9/00; H04N 5/445; H04H 9/00; G06F 3/00

(52) U.S. Cl. 725/11; 725/37; 348/734; 725/38; 382/115

(57) ABSTRACT

A method includes providing a remote control unit to allow a user to transmit control signals to an electronic device when the user is at a distance from the electronic device. The method further includes detecting a biometric characteristic of the user via the remote control unit.

### BACKGROUND

Many households have consumer electronic devices such as personal video recorders and cable television set top boxes. Other devices are growing in popularity or are expected to be introduced for consumer use, including so-called “media centers” that may in a centralized fashion allow a user to control various sources of information and entertainment, or advanced digital TVs. One design issue with respect to all consumer devices is ease and convenience of use. In households in which two or more users share the use of an electronic device, the needs and wishes of the various users may be different or even in conflict. This may result in design challenges that have not yet been successfully met.

### BRIEF DESCRIPTION OF THE DRAWINGS

FIG. 1 is block diagram of a system provided in accordance with some embodiments.

FIG. 2 is a block diagram of a remote control unit that is part of the system of FIG. 1.

FIG. 3 is a schematic representation of a control key layout according to some embodiments of the remote control unit of FIGS. 1 and 2.

FIG. 4 is a schematic representation of a control key layout according to some other embodiments of the remote control unit of FIGS. 1 and 2.

FIG. 5 is a block diagram of an electronic device that is responsive to the remote control unit of FIG. 2 and is incorporated in and/or coupled to a digital television that is shown in FIG. 1.

FIG. 6 is a flow chart that illustrates a process or processes that may be performed by the system of FIG. 1.

### DETAILED DESCRIPTION

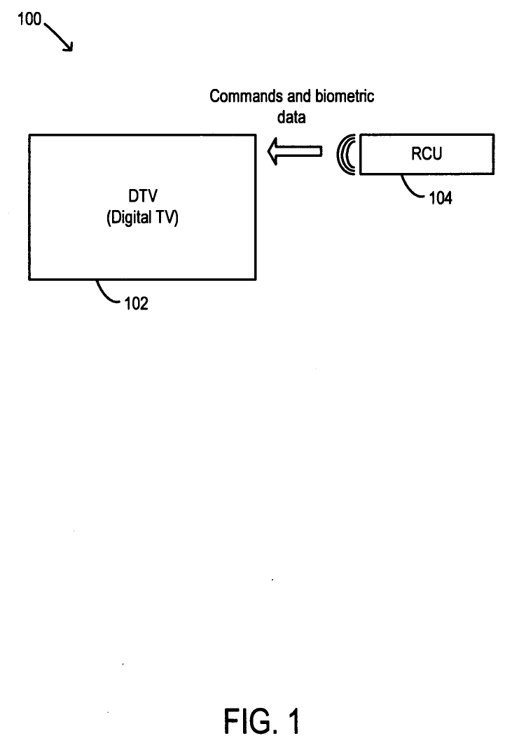

FIG. 1 is a block diagram of a system 100 that is provided in accordance with some embodiments. As shown, the system 100 includes a digital television 102 and a remote control unit 104 that selectively provides control signals by a wireless signal channel to the digital television 102. The digital television 102 may have integrated therein circuitry and devices to provide one or more functions for providing content to be displayed/reproduced by the television. For example, the integrated components may provide a digital video recording function like that of a personal video recorder. In addition or alternatively, the integrated components may provide functions conventionally provided by a cable television set top box. Alternatively, the DTV 102 may be any electronic device that may be controlled by a remote control device.

In accordance with some embodiments the remote control unit 104 includes a component (not separately shown in FIG. 1) for collecting biometric data from the user and for either relaying the biometric data to the digital TV 102 or for indicating the user's identity to the digital TV 102. The digital TV may respond to the biometric data and/or the identity of the user by tailoring its operation to the user's wishes and/or privileges within the system.

At least in some embodiments, the remote control unit allows a user to transmit control signals to the digital TV when the user is at a distance from the electronic device. (As used herein and in the appended claims, “at a distance” shall mean at least two meters away. This is not to imply that the remote control unit would not operate at closer range.) The biometric data collecting component of the remote control unit allows the system to detect a biometric characteristic of the user via the remote control unit.

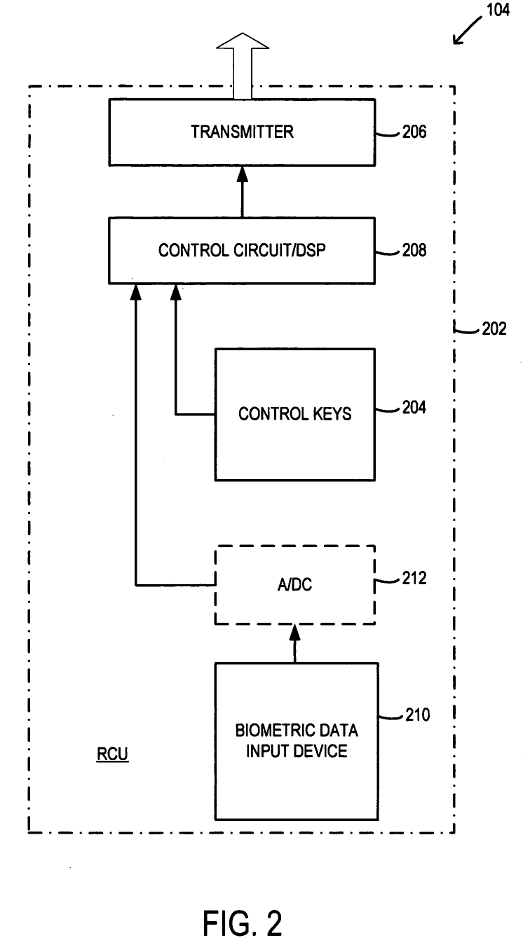

FIG. 2 is a block diagram of the remote control unit 104 as provided in accordance with some embodiments. The remote control unit 104 includes a housing 202 that is shaped and sized to be held in a user's hand. The remote control unit 104 firther includes control keys 204 (examples described below) that are mounted on the housing. The control keys may be actuated by the user to dispatch control signals to the digital TV. More specifically, the remote control unit includes a transmitter 206 that is mounted in the housing 202 and is responsive to the control keys 204 to transmit the control signals to the digital TV 102. In some embodiments, the remote control unit may include a control circuit and/or digital signal processor (represented by block 208) which is contained in the housing 202 and couples the control keys 204 to the transmitter 206.

The transmitter 206 may, in some embodiments, transmit the control signals via a wireless signal channel such as an infrared signal channel or a radio frequency signal channel.

Further, in accordance with some embodiments, the remote control unit includes a biometric data input device 210 mounted in and/or on the housing 202. In some embodiments the biometric data input device 210 is a fingerprint scanner that is properly positioned on the housing 202 to capture an image of a fingerprint from one or more of the fingers of the hand of a user who is holding and/or operating the remote control unit. (As used herein and/or in the appended claims, “finger” may include a thumb and “fingerprint” may include a thumbprint.)

In other embodiments, the biometric data input device 210 may include a microphone to generate a voice signal from a verbal utterance of the user, and suitable circuitry to capture and store a sample of the user's speech so that one or more characteristics of the user's voice may be detected.

The remote control unit 104 may also include an analog-to-digital converter 212 to couple the biometric data input device (e.g., a microphone) to the control circuit/DSP 208 to facilitate capture of biometric (e.g., voice signal) data. The storing of the voice signal, if a microphone is included, may be associated with the control circuit/DSP 208 rather than part of the biometric data input device 210. Where a microphone is part of the biometric data input device 210, the transmitter 206 may be responsive to the microphone to transmit to the digital TV at least one of a voice signal generated by the microphone and signals indicative of at least one characteristic of the voice signal. The control circuit/DSP 208 may function to generate the signals indicative of at least one characteristic of the voice signal by analyzing the voice signal generated by the microphone. The control circuit/DSP 208 may provide to the transmitter the signals indicative of at least one characteristic of the voice signal. It will be observed that the control circuit/DSP is coupled between the microphone and the transmitter, if it is assumed that the biometric data input device 210 is or includes a microphone.

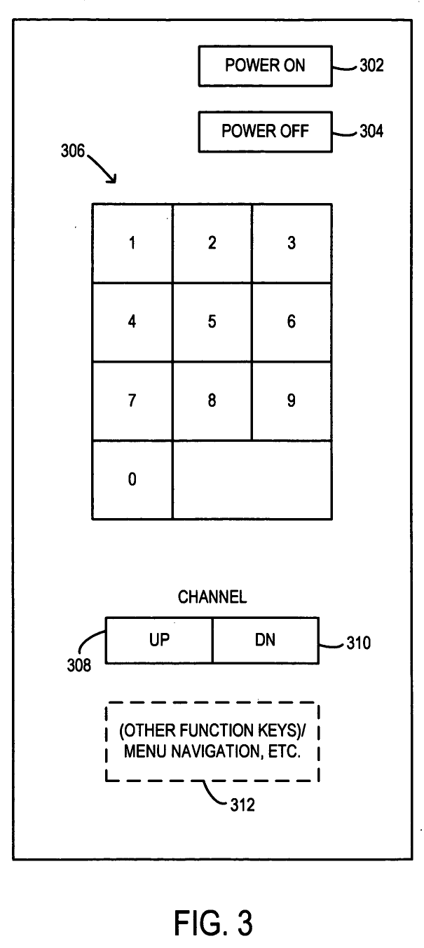

FIG. 3 is a schematic representation of a control key layout according to some embodiments of the remote control unit 104. In the layout shown in FIG. 3, the keys may be suitable for controlling set top box finctions. The control keys 204 (FIG. 2) thus may include, for example, a power-on key 302 and a power-off key 304, and a numeric key pad 306 for, e.g., entering the number of a cable television channel that the user wishes to tune to. The control keys 204 may further include keys 308, 310 for respectively incrementing and decrementing the channel number from that to which the digital TV is currently tuned. By use, for example, of keys 306, 308, 310, the remote control unit is operable by the user to select a television channel such as a cable television channel. Thus the keys 306, 308, 310 may be considered to be channel selection keys.

The control keys on the remote control unit may include other keys, indicated collectively in phantom at 312, to control other functions of the remote control unit and/or of the digital TV. Such other functions may, for example, include invoking one or more menus to be displayed by the digital TV and/or navigating among menu items included in such menus.

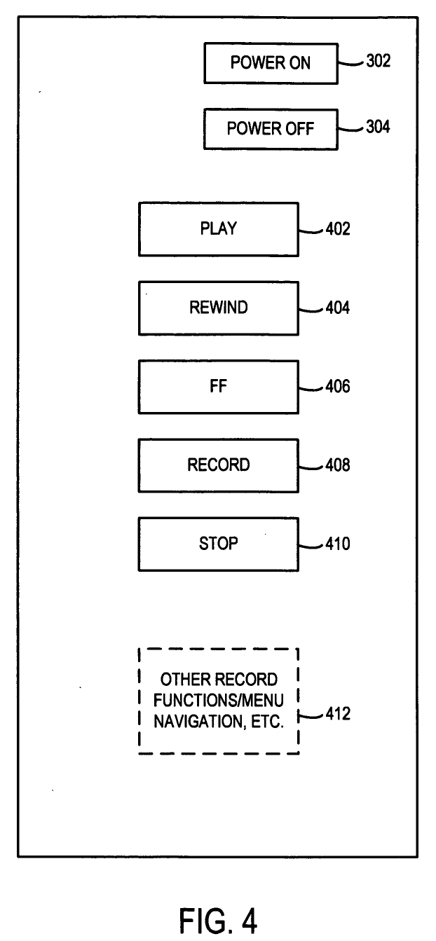

FIG. 4 is a schematic representation of a control key layout according to some other embodiments of the remote control unit 104. In the layout shown in FIG. 4, the keys may be suitable for controlling digital video recording functions such as those of a PVR. As before, the control keys may include a power-on key 302 and a power-off key 304. In addition, the control keys may include keys for selecting record finctions, such as “play” key 402, “rewind” key 404, “fast forward” key 406, “record” key 408 and “stop” key 410.

The control keys on the remote control unit may include other keys, indicated collectively in phantom at 412, to control other functions of the remote control unit and/or of the digital TV. Such other functions may, for example, include invoking one or more menus to be displayed by the digital TV and/or navigating among menu items included in such menus. The other functions may further include, for example, functions relating to video recording capabilities of the digital TV, such as keys to allow a time-code to be entered to navigate to a particular point in a stored video program.

In some embodiments, the key layouts of FIGS. 3 and 4 may be at least partially combined so that a single embodiment of the remote control unit may be suitable for controlling both set top box channel selection functions and digital video recording functions.

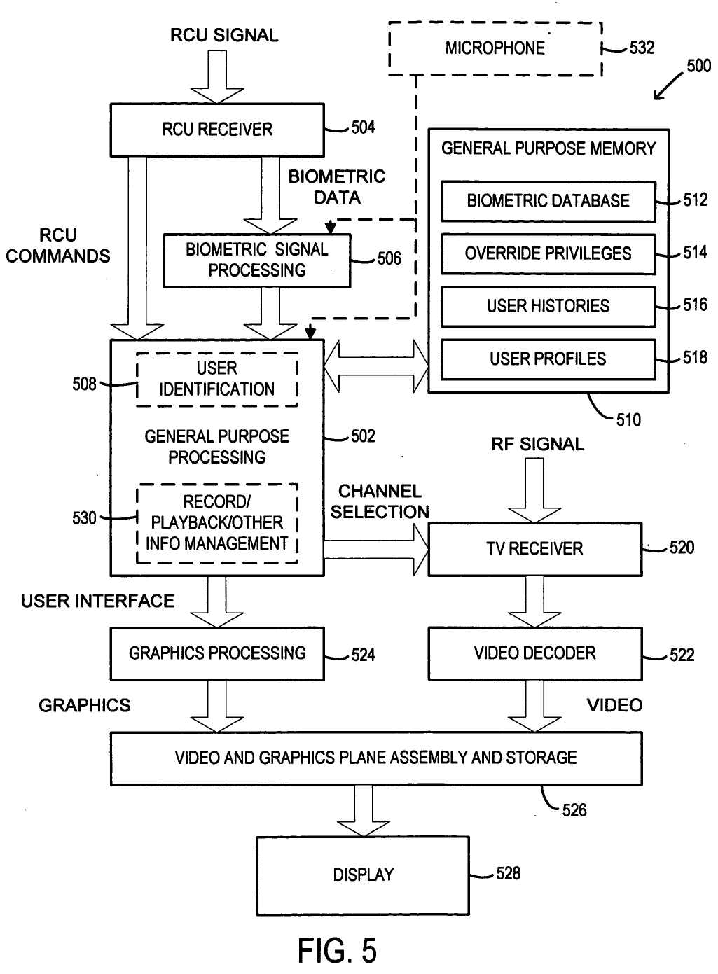

FIG. 5 is a functional block diagram of aspects of the digital TV 102. Alternatively, the circuitry 500 shown in FIG. 5 may represent a stand-alone set top box (also known as a “set top unit”) that is coupled to a TV and/or a stand-alone PVR, a media center, or other device coupled to the TV to control the signal reproduced by the TV. In some embodiments the TV may be a conventional TV monitor coupled to and/or controlled by one or more devices of the type referred to in the previous sentence.

The circuitry 500 may include a general purpose processing block 502, that may be constituted by one or more conventional processors, such as microprocessors, microcontrollers and/or digital signal processors. The circuitry 500 may further include a remote control signal receiver 504 that is coupled to the general purpose processing block 502. The receiver 504 may receive the wireless control signals transmitted from the remote control unit and may translate the control signals into commands for the general purpose processing block 502.

The circuitry 500 may further include a biometric signal processing block 506 which may be coupled between the remote control signal receiver 504 and the general purpose processing block 502 (or alternatively the biometric signal processing function may be at least partially integrated with the general purpose processing block 502). The biometric signal processing block 506 may receive from the receiver 504 biometric data contained in signals transmitted from the remote control unit which reflect biometric information collected by the remote control unit from the current user of the remote control unit. The biometric data processing block 506 may process the biometric data in such a manner that the general purpose processing block is able to proceed with identifying the current user of the remote control unit. Processing of the general purpose processing block 502 to identify the current user of the remote control unit is indicated in phantom at 508.

The circuitry 500 may also include a general purpose memory device 510 coupled to the general purpose processing block 502. In some embodiments, the general purpose memory device 510 may store one or more programs to control operation of the general purpose processing block 502. The general purpose memory device 510 may be constituted by one or more conventional devices such as RAM (random access memory), ROM (read only memory) and flash memory. The general purpose memory device 510 may further include data storage facilities that aid the circuitry 500 in identifying users and/or modifying and/or directing operation in response to the detected identities of users. Thus, for example, the general purpose memory device 510 may include one or more databases such as biometric database 512 to store biometric data detected from time to time for the various users of the system 100, override privileges database 514 that indicates what control function override privileges have been established for one or more of the users, user history database 516 that maintains a history of what activities/system functions/television channels have been invoked by the various users, and user profile database 518 that stores preferences and/or other information to allow the system to operate in accordance with particular needs/wishes of the various users. In some embodiments, the user history database 516 may store selections (e.g., channel selections) made by users and the stored selections made by each user may be stored in association with biometric data associated with each user.

The circuitry 500 may also include a television receiver 520 coupled to receive one or more radio frequency television signals and to select one of the signals in response to a channel selection signal provided to the TV receiver 520 from the general purpose processing block 508. Thus the TV receiver 520 may be coupled to a cable (not shown) or an antenna (not shown) to receive the RF television signals and may also be coupled to the general purpose processing block 502 to receive the channel selection signal.

The circuitry 500 may also include a video decoder 522 coupled to the TV receiver 520 to receive and decode the television channel signal selected via the TV receiver 520.

In addition, the circuitry 500 may include a graphics processing block 524 coupled to the general purpose processing block 502. The general purpose processing block 502 may output to the graphics processing block 524 commands to generate graphics image data to implement user interface display elements, and the graphics processing block 524 may generate graphics image data in accordance with such commands.

Still further, the circuitry 500 may include a video/graphics plane assembly and storage block 526 coupled to the video decoder 522 and to the graphics processing block 524. The video/graphics plane assembly and storage block 526 may form composite images from the decoded video signal provided by the video decoder 522 and the graphics image data generated by the graphics processing block 524 and may store the resulting composite images before outputting the same for display (as indicated by block 528) by the CRT or other display element of the digital TV.

In some embodiments, the circuitry 500 may have digital video recording capabilities, like those of a PVR (personal video recorder). In such embodiments, the circuitry 500 may include a mass storage device (not shown) such as a hard disk drive and/or a read/write DVD drive. Moreover, in such embodiments, the general purpose processing block 502 may have capabilities for controlling recording and playback functions, as indicated at 530. In addition, or alternatively, the circuitry 500 may be part of a so-called media center, or the like and may have capabilities for more generally controlling information flow within the user's household. For example, the circuitry 500 may be connected to the Internet and may be arranged to selectively route e-mail messages, data downloads and other information for display by the digital TV. (As used herein and in the appended claims, the term “data file” includes, but is not limited to, user settings, e-mail messages, updates, downloads and recorded data files.)

In some embodiments the remote control unit and the RCU receiver 504 may be partially or completely replaced or supplemented by a microphone 532 (shown in phantom) incorporated in the circuitry 500 (and hence in DTV 102) to receive voice commands from a user and to directly receive biometric data (voice characteristics) from the user. For that purpose the microphone 532, if present, may be coupled to one or both of the biometric signal processing block 506 and the general purpose processing block 502. (Although not shown in the drawing, the circuitry 500 may include suitable buffering/conditioning circuitry, such as an analog-to-digital converter, coupled between the microphone 532 and the biometric signal processing block 506 and/or the general purpose processing block 502.)

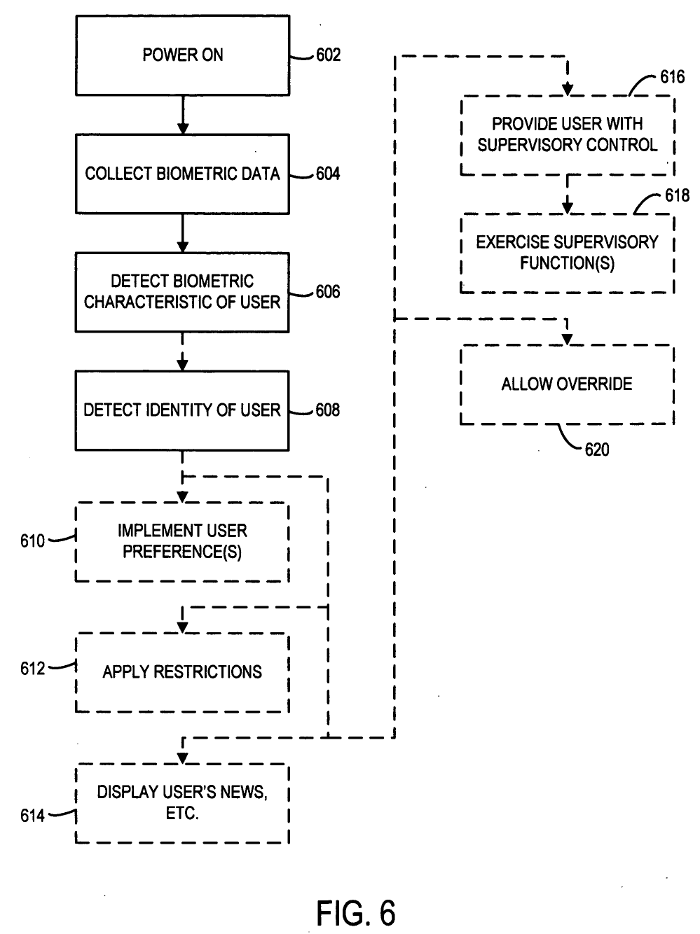

FIG. 6 is a flow chart that illustrates a process or processes that may be performed by the system 100.

At 602 in FIG. 6, the digital TV 102 may be powered up in response to a suitable control signal transmitted from the remote control unit 104. (It will be appreciated that when the digital TV is not in a fully powered up condition, it may be in a sleep mode in which it is able to detect a “power-on” control signal from the remote control unit.) Then, at 604, the system 100 collects, via the remote control unit, biometric data from the user of the remote control unit. For example, if the remote control unit includes a fingerprint scanner, the remote control unit may capture either an image of the user's fingerprint or certain characteristics of the user's fingerprint and may transmit data that represents the fingerprint image or fingerprint characteristics to the digital TV. In other embodiments, where the remote control unit includes a microphone, the digital TV may prompt the user to speak a password or the like into the microphone, and then the remote control unit may capture either a voice signal that corresponds to the spoken password or certain characteristics of the user's voice detected by analyzing the user's utterance of the password. The remote control unit may then transmit the voice signal or data that represents the user's voice characteristics to the digital TV.

As indicated at 606, one or more biometric characteristics of the user of the remote control unit are detected, either at the remote control unit or at the biometric signal processing block 506 (FIG. 5) and/or general purpose processing block 502 of the digital TV. The biometric characteristics of the user may be detected based on the biometric data collected at 604. Then, as indicated at 608, the general purpose processing block 502 of the digital TV detects the identity of the user based on the biometric characteristic(s) detected at 606. Thus the digital TV now “knows” who is currently using the remote control unit. (The digital TV may know the current user by the user's actual name, if the user's name and identifying biometric data were entered during operation in a set-up mode. Alternatively, the digital TV may know the user, in effect, only as “user no. 1”, e.g., or other designation applied to the user by the digital TV itself.)

Based on knowing the user's identity, the digital TV may automatically take one or more of a number of different actions to enhance the user's operation of the system, improve convenience of use, and/or implement parental control regimes, etc. For example, as indicated at 610, the digital TV may automatically implement one or more preferences of the user identified at 608. For example, if the digital TV knows that the current user has a favorite TV channel, the digital TV may automatically select that channel in response to the detected identity of the user, without requiring the user to make that channel selection by actuating control keys on the remote control unit. The digital TV may further know that the user's favorite TV channel varies with time of day and/or day of the week. As a result, a channel that is automatically selected by the digital TV in response to detecting the user's identity may also vary with time of day and/or day of the week. The digital TV may gain its knowledge of the user's TV channel preferences as a result of the user programming such preferences (e.g., by entering data) during a set-up mode of the system. Alternatively, the digital TV may infer the user's TV channel preferences by tracking and storing data regarding the channels selected by the user from time to time as the user uses the remote control unit. Thus, the digital TV may infer the user preferences from data stored in the user history database 516 (FIG. 5).

The digital TV may remember/infer and automatically implement other user preferences in addition to or instead of favorite TV channels. For example, the digital TV may implement user preferences in regard to sound volume, picture contrast, color adjustment or the like. If the circuitry shown in FIG. 5 is part of a media center or other central controller that is part of the system and controls the TV and lighting or other environmental conditions (automatic blinds, etc.) the system may automatically implement user preferences in regard to lighting and/or other environmental conditions. The user may also be allowed to program his/her preferences in regard to menu fonts and formats, etc., and such preferences may be automatically implemented by the system in the future in response to the system detecting that the user is the current user of the remote control unit.

In some embodiments, the digital TV may, as indicated at 612, be programmed to restrict access to at least one TV channel in response to the detected identity of the user of the remote control unit. For example, during a set-up or parental control session of the system, an adult user of the system may enter data to indicate that one or more child users may not view certain channels and/or that the child user(s) may not watch any TV at all during certain hours, such as from 4:00 to 6:00 p.m., Monday through Thursday. Consequently, if a user subject to restrictions is detected at 608 to be the current user of the remote control unit, (a) the digital TV may refuse to implement selection of certain channels indicated by signals from the remote control unit; and/or (b) if a “blackout” (homework) period is currently in effect, the digital TV may refrain from displaying any TV programming and instead may display a notice to the effect of “No TV Now, Please Do Your Homework”.

The restrictions applied at 612 may have been programmed into the system by a user who has supervisory privileges. Programming of restrictions by the supervisory user may be guided by a “wizard” software module or the like.

In some embodiments, assuming the circuitry of 500 to be part of a media center or having similar functionality, the system may be programmed to select one or more data files for display on the digital TV in response to the detected identity of the current user of the remote control device. “Data files”, as used herein and in the appended claims, may refer for example to electronic mail messages, downloads from the Internet, automatic news updates gathered by a browser or other program in accordance with the user's preferences, etc. In one scenario, indicated at 614, in response to the identity of the user detected at 608, the circuitry 500 may cause the digital TV to display a news update that is customized for the detected user and is automatically downloaded daily or at other regular intervals from the Internet. A field in such a display (not shown) may allow the detected user to access his/her e-mail messages and to display them on the digital TV by actuation of appropriate control keys on the remote control unit.

In some embodiments, if the user whose identity is detected at 608 has previously been assigned a supervisory role for the system (e.g., during set-up or the like), the system may respond to the detection of the user's identity by providing the user with access to supervisory control levels of operation of the system, as indicated at 616. If the user acts to access such fuictions (e.g., by selecting an appropriate menu item by actuating control keys on the remote control unit), the user may proceed to exercise supervisory functions (618 in FIG. 6). The supervisory functions may include, for example, (a) changing privileges and/or restrictions and/or preferences for other users of the system, (b) disabling or enabling the TV for certain periods of the day or the week, (c) adding or removing a user to/from the system (including collecting introductory biometric data from the new user), etc.

In some embodiments, the system may, as indicated at 620, allow the user identified at 608 to override the current control status of the system, assuming that the user has been registered with the system as having override privileges. For example, if the TV is in a blackout period (previously programmed to be inoperative for a period of time), a user having override privileges, when identified as the current user of the remote control unit, may be allowed to turn on the TV, select channels, etc. In another example, a user with override privileges may approach the remote control unit (assumed in this case to include a microphone) and utter a phrase such as “no more TV”. In response, the system may identify the user and cause the TV to be inactivated for (say) an hour to allow for an uninterrupted dinner time or the like. During the period of inactivation, the system may operate such that only the user having override privileges can cause the TV to become operable again.

It should be understood that most or all of the functions ascribed herein to the digital TV may in other embodiments be performed by one or more stand-alone devices coupled to a television. Such devices may include a set top box (also referred to as a “set top unit”) and/or a PVR.

In some embodiments, all user identification functions may be performed in the remote control unit, rather than being divided between the remote control unit and the digital TV.

In a system like that described herein, wherein the remote control unit collects biometric data to permit identification of the current user of the remote control unit, behavior of the system can be tailored to the user's preferences or otherwise controlled to enhance the usability of the system and to provide desirable features. As a result the convenience of use of the system may be enhanced.

The several embodiments described herein are solely for the purpose of illustration. The various features described herein need not all be used together, and any one or more of those features may be incorporated in a single embodiment. Therefore, persons skilled in the art will recognize from this description that other embodiments may be practiced with various modifications and alterations.

What is claimed is:

1. A method comprising:
providing a remote control unit to allow a user to transmit control signals to an electronic device when the user is at a distance from the electronic device; and
detecting a biometric characteristic of the user via the remote control unit.

2. The method of claim 1, wherein the remote control unit transmits the control signals directly to the electronic device via a wireless signal channel.

3. The method of claim 2, wherein the wireless signal channel is an infrared signal channel.

4. The method of claim 2, wherein the wireless signal channel is a radio frequency signal channel.

5. The method of claim 1, wherein the electronic device is a set top unit to control a signal displayed on a television screen.

6. The method of claim 1, wherein the remote control unit is operable to select a television channel.

7. The method of claim 1, wherein the remote control unit is operable to control a personal video recorder.

8. The method of claim 1, wherein the biometric characteristic is a fingerprint.

9. The method of claim 1, wherein the biometric characteristic is a characteristic of the user's voice.

10. A remote control unit, comprising:
a housing;
a set of control keys mounted on the housing;
a transmitter mounted in the housing and responsive to the control keys to transmit control signals to an electronic device; and
a biometric scanner mounted on the housing;
wherein the control keys include at least one of a channel selection key and a record function key.

11. The remote control unit of claim 10, wherein the transmitter is an infrared transmitter.

12. The remote control unit of claim 10, wherein the transmitter is a radio frequency transmitter.

13. The remote control unit of claim 10, wherein the control keys include a numeric key pad.

14. A remote control unit, comprising:
a housing;
a set of control keys mounted on the housing;
a transmitter mounted in the housing and responsive to the control keys to transmit control signals to an electronic device; and
a microphone mounted on the housing;
wherein:
the control keys include at least one of a channel selection key and a record function selection key; and
the transmitter is responsive to the microphone to transmit at least one of the following to the electronic device:
a voice signal generated by the microphone; and
signals indicative of at least one characteristic of said voice signal.

15. The remote control unit of claim 14, wherein the transmitter is an infrared transmitter.

16. The remote control unit of claim 14, wherein the transmitter is a radio frequency transmitter.

17. The remote control unit of claim 14, wherein the control keys include a numeric key pad.

18. The remote control unit of claim 14, further comprising:
a circuit coupled between said microphone and said transmitter to generate said signals indicative of at least one characteristic of said voice signal and to provide said signals to said transmitter.

19. A system comprising:
an electronic device coupled to a television to select television signals and to supply the selected television signals to the television; and
a remote control unit to selectively and wirelessly transmit control signals to said electronic device;
said remote control unit including a biometric data input device;
said electronic device programmed to detect an identity of a user of said remote control unit based on biometric data received via the biometric data input device of said remote control unit.

20. The system of claim 19, wherein said biometric data input device includes at least one of:
a fingerprint scanner; and
a microphone.

21. The system of claim 19, wherein said remote control unit includes a plurality of control keys.

22. The system of claim 21, wherein said control keys include at least one of a channel selection key and a record function selection key.

23. The system of claim 22, wherein said electronic device is a set top unit.

24. The system of claim 22, wherein said electronic device is a personal video recorder.

25. The system of claim 19, wherein said electronic device and said television are integrated in a common housing.

26. The system of claim 25, wherein said electronic device is to perform both cable television tuning and digital video recording.

27. The system of claim 19, wherein said electronic device is programmed to automatically select a television channel in response to the detected identity of the user of the remote control unit.

28. The system of claim 19, wherein said electronic device is programmed to restrict access to at least one television channel in response to the detected identity of the user of the remote control unit.

29. The system of claim 19, wherein said electronic device is programmed to select at least one data file for display on said television in response to the detected identity of the user of the remote control device.

30. The system of claim 19, wherein said electronic device is programmed to provide a level of supervisory control of the system to said user based on the detected identity of said user.

31. The system of claim 19, wherein said electronic device is programmed to detect and store selections made by a user and to associate said stored selections with biometric data collected from said user.

32. A system comprising:
an electronic device coupled to a television to select television signals and to supply the selected television signals to the television;
wherein:
said electronic device includes a microphone to generate a voice signal; and
said electronic device is programmed to identify a user of the system based at least in part on said voice signal.

33. The system of claim 32, wherein said electronic device is a set top unit.

34. The system of claim 32, wherein said electronic device is a personal video recorder.

35. The system of claim 32, wherein said electronic device and said television are integrated in a common housing.
